(19) United States
(12) Patent Application Publication
(10) Pub. No.: US 2008/0159828 A1
(43) Pub. Date: Jul. 3, 2008

(54) THREADED FASTENER

(75) Inventor: XIU-WEN CHEN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 11/842,168

(22) Filed: Aug. 21, 2007

(30) Foreign Application Priority Data
Dec. 28, 2006 (CN) 200610201442.8

(51) Int. Cl. F16B 23/00

(52) U.S. Cl. 411/405

(57) ABSTRACT

An exemplary threaded fastener (20) includes a fastener head (21) and a fastener crown (22). The fastener crown extends out from one end of the fastener head. The fastener crown includes at least two protrusions extending from out the end of the fastener head. The threaded fastener can be melted into a metallic sheet without welded ripple and the metallic sheet has a good esthetic appearance.

### CROSS-REFERENCE TO RELATED APPLICATIONS

This application is related to a co-pending U.S. patent application Ser. No. [to be determined] (Attorney Docket No. US13452), and entitled “THREADED FASTENER” wherein the inventor is Xiu-Wen Chen. The application has the same assignee as the present application. The disclosures of the above identified applications are incorporated herein by reference.

### BACKGROUND OF THE INVENTION

1. Field of the Invention

The present invention relates, generally, to fasteners, and more particularly to a threaded fastener which can be securely and firmly welded into a metallic sheet.

2. Discussion of the Related Art

Generally, a threaded fastener can be welded into a metallic sheet, and engage with a nut so as to mount other metallic elements with the metallic sheet.

Referring to FIG. 8, a typical threaded fastener 10 includes a fastener head 11, a fastener crown 12, and a threaded portion 13. The fastener crown 12 is a cylindrical pole extending out from an end of the fastener head 11 and the threaded portion 13 extends out from an opposite end of the fastener head 11. The fastener crown 12 has a radius smaller than that of the threaded portion 13.

Referring to FIG. 9, the threaded fastener 10 is held by a welded device 15 and is placed above a metallic sheet 16. A voltage is applied to the fastener crown 12 of the threaded fastener 10 by the welded device 15 so that a relative large electric potential difference is produced between the fastener crown 12 and the metallic sheet 16, thereby causing electric arcs to be produced between the fastener crown 12 and the metallic sheet 16. The electric arcs have a high temperature that heats part of the fastener crown 12 and part of the metallic sheet 16 below the fastener crown 12, thus the part of the fastener crown 12 is then melted and a melted area (not shown) is produced on a top surface of the metallic sheet 16. The fastener crown 12 of the threaded fastener 10 is then pushed into the melted area of the metallic sheet 16. When the threaded fastener 10 and the metallic sheet 16 are cooled, the threaded fastener 10 and the metallic sheet 16 are fused together.

Since the fastener crown 12 of the threaded fastener 10 is a small cylindrical pole and the corresponding melted area of the metallic sheet 16 is also small, thus the heat produced by the electric arcs are centralized between the threaded fastener 10 and the melted area. As a result, an area of a bottom surface of the metallic sheet 16 opposite the melted area is also prone to be melted and this creates welded ripples in the area of the bottom surface of the metallic sheet 16. The welded ripples may give the false impression that the strength of the bond between the fastener and the metallic sheet 16 may be inferior. Additionally, the welded ripples will also affect the esthetic appearance of the sheet 16. In order to reduce welded ripples, a relative lower voltage is applied to the fastener crown 12 of the threaded fastener 10, thus the intensity of the electric arcs is decreased, and accordingly the heat centralized between the threaded fastener 10 and the melted area will be decreased, thus the welded ripples can also be reduced. However, by lowering the voltage the fastener crown 12, of the threaded fastener 10, cannot be strongly fused to the metallic sheet 16, thus the strength of the bond between the fastener crown 12 of the threaded fastener 10 and the metallic sheet 16 is unduly small.

What is needed, therefore, is a new threaded fastener which can overcome the above-mentioned disadvantages.

### SUMMARY

An exemplary threaded fastener includes a fastener head and a fastener crown. The fastener crown extends out from one end of the fastener head. The fastener crown includes at least two protrusions extending out from the end of the fastener head. The threaded fastener can be melted to a metallic sheet without welded ripple and the metallic sheet has a good esthetic appearance.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the melding screw. Moreover, in the drawings, like reference numerals designate corresponding parts throughout the several views, and all the views are schematic.

FIG. 1 is an isometric view of a threaded fastener in accordance with a first preferred embodiment of the present invention.

FIG. 2 is a cross-sectional view of a weld device for welding the threaded fastener of FIG. 1 to a metallic sheet.

FIG. 3 is an isometric view of a threaded fastener in accordance with a second preferred embodiment of the present invention.

FIG. 4 is an isometric view of a threaded fastener in accordance with a third preferred embodiment of the present invention.

FIG. 5 is an isometric view of a threaded fastener in accordance with a fourth preferred embodiment of the present invention.

FIG. 6 is a cross-sectional view of a threaded fastener in accordance with a fifth preferred embodiment of the present invention.

FIG. 7 is a cross-sectional view of a threaded fastener in accordance with a sixth preferred embodiment of the present invention.

FIG. 8 is an isometric view of a conventional threaded fastener.

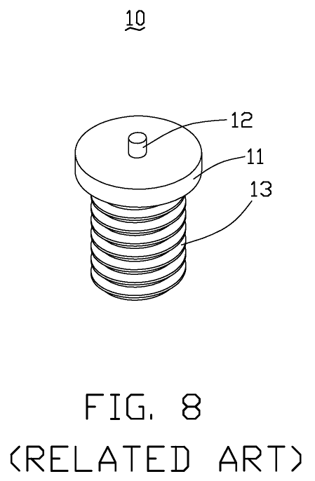

FIG. 9 is a cross-sectional view of a weld device for welding the threaded fastener of FIG. 8 to a metallic sheet.

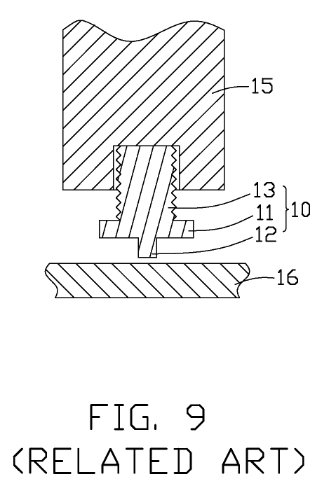

### DETAILED DESCRIPTION OF THE EMBODIMENTS

Reference will now be made to the drawings to describe preferred embodiments of the present threaded fastener in detail.

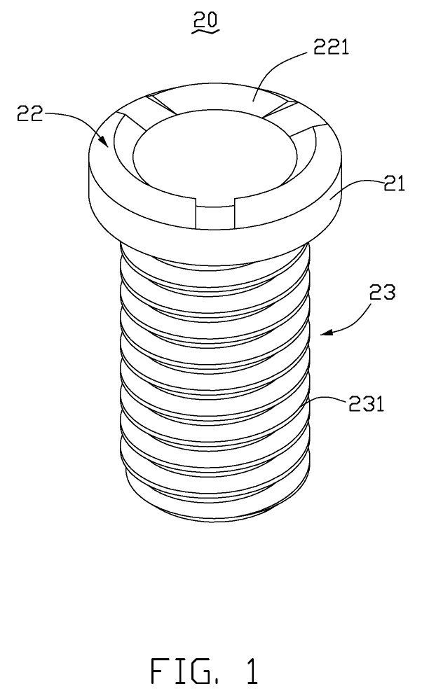

Referring to FIG. 1, a threaded fastener 20 according to a first embodiment is shown. The threaded fastener 20 includes a fastener head 21, a fastener crown 22, and a threaded portion 23 adjoining the fastener head 21. The fastener head 21 and the threaded portion 23 are cylindrical. The threaded portion 23 is threaded for its entire length and has a radius smaller than that of the fastener head 21. The fastener crown 22 includes a plurality of protrusions 221 extending out from a circumference fringe of the fastener head 21 opposite to the threaded portion 23. The protrusions 221 are spaced apart from each other. In this embodiment, the protrusions 221 are arc-shaped protrusions and each protrusion 221 has a similar triangular cross-section taken along a plane passing through a cylindrical axis of the fastener head 21. The number of the protrusions 221 is preferred to be three. The threaded fastener 20 is made of metallic materials such as copper, or aluminum. In alternative embodiments, the protrusions can be other shapes such as a stripe shape.

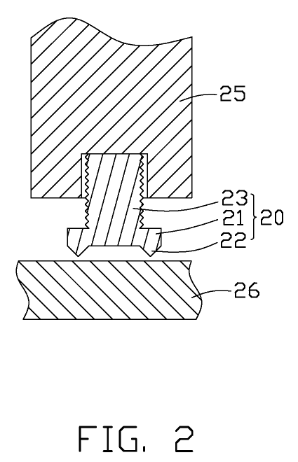

Referring to FIG. 2, the threaded fastener 20 is held by a welded device 25 and is placed above a top surface of a metallic sheet 26. A voltage is applied to the fastener crown 22 of the threaded fastener 20 by the welded device 25 so that a relative large electric potential difference is produced between the fastener crown 22 and the metallic sheet 26, causing electric arcs between the fastener crown 22 and the metallic sheet 26. The electric arcs have a high temperature that heats part of the fastener crown 22 and part of the metallic sheet 26 below the fastener crown 22, thus, part of the fastener crown is then melted and a melted area (not shown) is also produced on the metallic sheet 26. The fastener crown 22 of the threaded fastener 20 is then pushed into the melted area of the metallic sheet 26. When the threaded fastener 20 and the metallic sheet 26 are cooled, the threaded fastener 20 and the metallic sheet 26 are fused together.

Since the fastener crown 22 of the threaded fastener 20 includes three protrusions 221, when the electric arcs heats the fastener crown 22 of the threaded fastener 20, the melted area produced by fastener crown 22 on the metallic sheet 26 is relative larger, and the electric arcs are more evenly distributed on the protrusions 221. As a result, the melted area is heated uniformly and an area of a bottom surface of the metallic sheet 26 opposite the melted area can be prevented from melting. Therefore, the threaded fastener 20 is melted to the metallic sheet 26 without welded ripples caused in the area of the bottom surface of the metallic sheet 26 corresponding to the melted area and the metallic sheet 26 and has a good esthetic appearance. In addition, because the voltage applied to the fastener crown 22 of the threaded fastener 20 is not decreased and each protrusion 221 has the similar triangular cross-section, the part of the protrusion 221 distal from the fastener head 21 is melted more easily so that the fastener crown 22 of the threaded fastener 20 can be firmly melted to the metallic sheet 26.

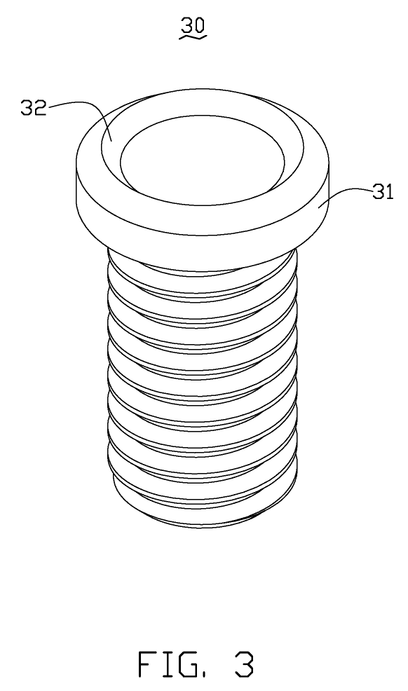

Referring to FIG. 3, a threaded fastener 30 according to a second preferred embodiment is shown. The threaded fastener 30 is similar in principle to the threaded fastener 20 described above. The threaded fastener 30 includes a fastener head 31 and a fastener crown 32. However, the fastener crown 32 is an annular protrusion extending from a circumferential fringe of an end of the fastener head 31.

In use, since the fastener crown 32 is an annular protrusion which has a relative larger surface, thus electric arcs can also be dispersedly distributed on the annular protrusion. As a result, the melted area of the metallic sheet 26 is heated uniformly and the threaded fastener 40 can also be melted to the metallic sheet 26 without welded ripples caused in the area of the bottom surface of the metallic sheet 26 corresponding to the melted area and the metallic sheet 26 has a good esthetic appearance.

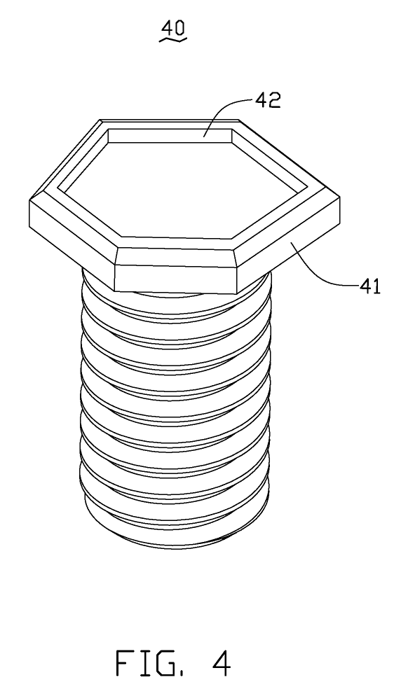

Referring to FIG. 4, a threaded fastener 40 according to a third preferred embodiment is shown. The threaded fastener 40 is similar in principle to the threaded fastener 30 described above. The threaded fastener 40 includes a fastener head 41 and a fastener crown 42. However, the fastener head 41 is a regular polygonal prism and the fastener crown 42 is a polygonal protrusion extending from a circumferential fringe of an end of the fastener head 41. The polygonal protrusion has a similar triangular cross-section taken along a plane passing through a cylindrical axis of the fastener head 41. In this embodiment, the fastener head 41 is a regular hexagonal prism and the polygonal protrusion is a hexagonal protrusion.

In use, since the fastener crown 42 is a polygonal protrusion which has a relative larger surface, thus electric arcs can also be dispersedly distributed on the polygonal protrusion. As a result, the melted area of the metallic sheet 26 is heated uniformly and the threaded fastener 40 can also be melted to the metallic sheet 26 without welded ripples caused in the area of the bottom surface of the metallic sheet 26 corresponding to the melted area and the metallic sheet 26 has a good esthetic appearance.

It can be understood that, in order to avoid welded ripples, the fastener crown 22, 32, and 42 in the above three embodiments can also extend from an area adjacent to the circumferential fringe of an end of the fastener head 41.

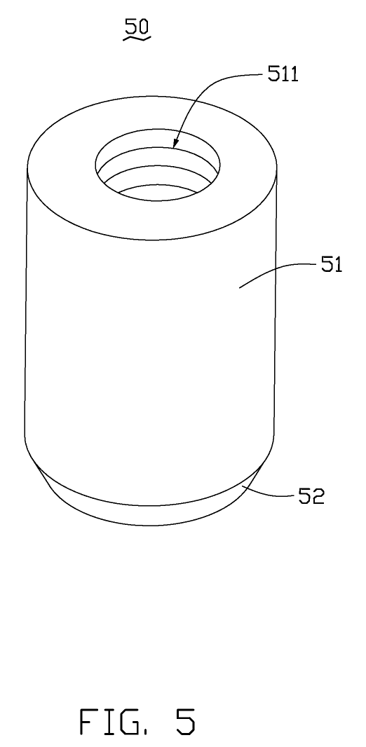

Referring to FIG. 5, a threaded fastener 50 according to a fourth preferred embodiment is shown. The threaded fastener 50 includes a fastener body 51 and a fastener crown 52 extending from an end of the fastener body 51. The structure of the fastener crown 52 is similar in principle to fastener crown 32 of the threaded fastener 30 shown in FIG. 3 in accordance with the second embodiment. The threaded fastener 50 is also made of metallic materials such as copper, or aluminum. However, the fastener body 51 defines a threaded hole 511 at an end of the fastener body 51 distal from the fastener crown 52. In alternative embodiments, the structure of the fastener crown 52 is similar in principle to fastener crown 22 of the threaded fastener 20 shown in FIG. 1 in accordance with the first embodiment.

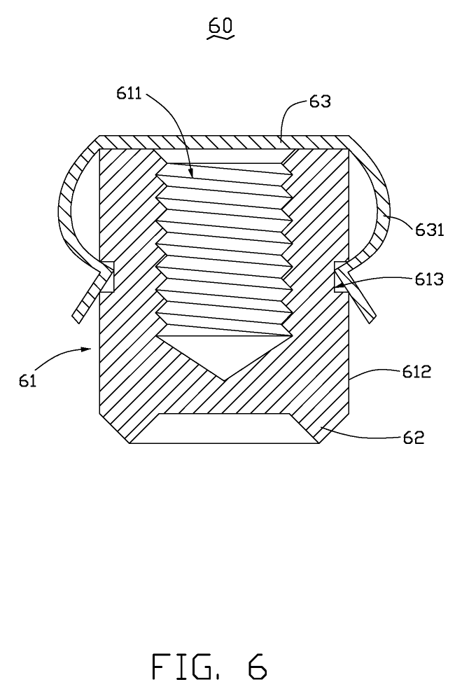

Referring to FIG. 6, a threaded fastener 60 according to a fifth preferred embodiment is shown. The threaded fastener 60 is similar in principle to the threaded fastener 50 described above. The threaded fastener 60 includes a fastener body 61 and a fastener crown 62. However, the fastener body 61 is a hollow cylinder and defines a threaded hole 611 at an end of the fastener body 61 distal from the fastener crown 62 and further defines two holding grooves 613 on a side surface 612 of the fastener body 61. A fastener cap 63 is covered on the end of the fastener body 61 distal from the fastener crown 62 and the fastener cap 63 includes two elastic holding pieces 631 received in the holding grooves 613.

In the fifth embodiment, because the elastic holding pieces 631 of the fastener cap 63 are received in the holding groove 613 the threaded fastener 60, thus the fastener cap 63 together with the threaded fastener 60 can be held by a weld device (not shown) and is placed above a metallic sheet (not shown). After the threaded fastener 60 is welded onto the metallic sheet, the elastic holding pieces 631 of the fastener cap 63 are released from the holding groove 613 of the threaded fastener 60 so that the fastener cap 63 can be separated from the threaded fastener 60. Because the threaded hole 611 is defined at the end of the fastener body 61 distal from the fastener crown 62 and a touching area for being held by a weld device is decreased, thus the threaded fastener 60 cannot directly be held by the weld device firmly. The fastener cap 63 is configured for increasing the touching area so that the threaded fastener 60 can be held firmly to place above the metallic sheet.

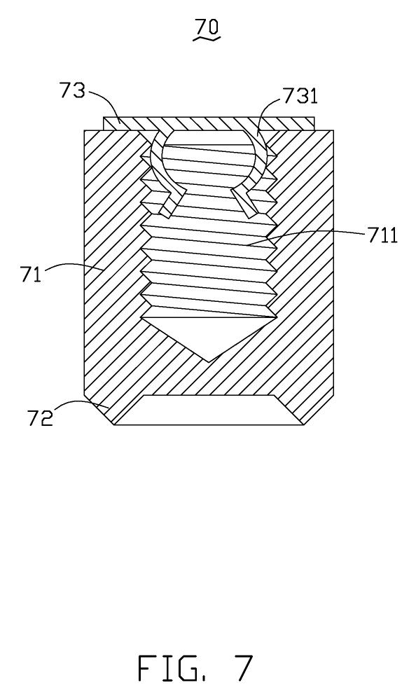

Referring to FIG. 7, a threaded fastener 70 according to a sixth embodiment is shown. The threaded fastener 70 is similar in principle to the threaded fastener 50 (see FIG. 5) described above. The threaded fastener 70 includes a fastener body 71 and a fastener crown 72. However, the fastener body 71 is a hollow cylinder and defines a threaded hole 711 at an end of the fastener body 71 distal from the fastener crown 72. A fastener cap 73 is covered on the end of the fastener body 71 distal from the fastener crown 72 and the fastener cap 73 includes two elastic holding pieces 731 received in the threaded hole 711. The fastener cap 73 is configured for increasing the touching area so that the threaded fastener 70 can be held firmly to place above a metallic sheet.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A threaded fastener, comprising:
a fastener head; and
a fastener crown extending out from one end of the fastener head, and the fastener crown including at least two protrusions extending out from the end of the fastener head.

2. The threaded fastener as claimed in claim 1, wherein the protrusions are arc-shaped protrusions and are spaced apart from each other.

3. The threaded fastener as claimed in claim 1, wherein the protrusions are stripe-shaped protrusions.

4. The threaded fastener as claimed in claim 1, wherein the protrusions extend from a circumferential fringe of the end of the fastener head.

5. The threaded fastener as claimed in claim 1, wherein the protrusions extend from an area adjacent to a circumferential fringe of the end of the fastener head.

6. The threaded fastener as claimed in claim 1, further comprising a threaded portion adjoining another end of the fastener head, and the threaded portion is threaded and has a radius smaller than that of the fastener head.

7. The threaded fastener as claimed in claim 6, wherein the threaded portion is cylindrical.

8. The threaded fastener as claimed in claim 1, wherein each protrusion has a similar triangular cross-section taken along a plane passing through a cylindrical axis of the fastener head.

9. The threaded fastener as claimed in claim 1, wherein the fastener head is cylindrical.

10. The threaded fastener as claimed in claim 1, wherein the fastener head is a regular prism.

11. A threaded fastener, comprising:
a fastener body;
a fastener crown extending out from one end of the fastener body, wherein the fastener crown comprises at least two protrusions extending out from the end of the fastener body, and each protrusion spaced apart from each other and has a similar triangular cross-section taken along a plane passing through a cylindrical axis of the fastener body.

12. The threaded fastener as claimed in claim 11, wherein the protrusions are three arc-shaped protrusions.

13. The threaded fastener as claimed in claim 11, wherein the protrusions are three stripe-shaped protrusions.

14. The threaded fastener as claimed in claim 1, wherein the protrusions extend from a circumferential fringe of the end of the fastener body.

15. The threaded fastener as claimed in claim 11, wherein the fastener body is a hollow cylinder and defines a threaded hole in an end of the fastener body distal from the fastener crown.

16. The threaded fastener as claimed in claim 15, wherein the fastener body defines two holding grooves on a side surface thereof.

17. The threaded fastener as claimed in claim 13, wherein the fastener body is cylindrical.

18. The threaded fastener as claimed in claim 13, wherein the fastener body is a regular prism.
